(19) United States
(12) Patent Application Publication
(10) Pub. No.: US 2025/0315496 A1
(43) Pub. Date: Oct. 9, 2025

(54) Systems and Methods for Transforming Documents to a Structured Searchable and Linked Format

(71) Applicant: Renyooit LLC, Pleasanton, CA (US)

(72) Inventors: Lakshmi Nagarajan, San Ramon, CA (US); Raja Nagarajan, San Ramon, CA (US); Saisriram Natarajan, Santa Clara, CA (US)

(21) Appl. No.: 19/174,086

(22) Filed: Apr. 9, 2025

Related U.S. Application Data
(60) Provisional application No. 63/631,818, filed on Apr. 9, 2024.

(51) Int. Cl. G06F 16/958; G06F 3/04842; G06F 40/109; G06V 30/10; G06V 30/414; G06V 30/416

(52) U.S. Cl. CPC G06F 16/986; G06F 3/04842; G06F 40/109; G06V 30/10; G06V 30/414; G06V 30/416

(57) ABSTRACT

An example method for pre-processing documents includes receiving, by a computing device, an initial document in digital format. The method includes detecting, by the computing device and based on a computerized analysis of the initial document, one or more attributes of the initial document. The one or more attributes may include a font detail or a vector graphics, or both. The method includes generating, by the computing device and based on the detected one or more attributes, a hierarchical structure associated with the initial document, the hierarchical structure interconnecting one or more components of the initial document. The method includes transforming, by the computing device and based on the hierarchical structure, the initial document to a modified document, wherein the modified document comprises one or more navigable links that facilitate computerized navigation of the hierarchical structure. The method includes providing, by the computing device, the modified document.

### CROSS REFERENCE TO RELATED APPLICATIONS

This application claims priority to U.S. Provisional Application No. 63/631,818 filed Apr. 9, 2024, the contents of which are incorporated herein in their entirety.

### BACKGROUND

Media content, such as images, video, audio, text files, and so forth, is a popular medium for sharing and/or transmitting information. Media content may be shared across multiple applications, including social media platforms, enterprise application service platforms, electronic commerce websites, news publications, educational resources, computer games, and so forth, to name a few. Also, for example, media content may be used in do-it-yourself (DIY) projects, engineering design, apparel design, instruction manuals for various products, product repair documents, and so forth.

### SUMMARY

As a popular adage goes, if an image is worth a thousand words, then an annotated image is likely to be worth many more. Indeed, many product manuals (e.g., instruction manuals, owners' manuals, repair manuals) are documents with multiple pages, and/or include highly technical diagrams, descriptions, etc. For example, a product manual may not illustrate a particular technical specification. Also, for example, the product manual may provide a generic, schematic illustration of a feature, and a user may not understand whether, or how, the description may apply to their particular product. Similarly, product design documents can be somewhat confusing when a user applying the design in a manufacturing of the product, or in constructing a building, or designing an apparel, is not able to quickly view design features of various parts of the product, building, apparel, etc. Even when the information is available, such information may be challenging to find within a user manual, and may require considerable time and effort on the part of the user to find the information, map it to their own product, understand the content, and then use the information.

User manuals, design documents, etc. may be lengthy, complex, and may include information that may not be relevant to the user at a particular point in time, or in response to a particular problem. Such user manuals, design documents, etc. may also make use of callouts that highlight specific points of images within the documents to provide additional context, or emphasis, or to link to textual information within the document. Also, for example, the information relevant to a specific topic or problem may not be available at one location in the document, and may instead be spread throughout the document on many different pages.

Accordingly, there is a need for a pre-processing solution that enables the parsing of user manuals, design documents, etc., and additionally transforms the data into a more readable, navigable, and annotatable presentation. Such a pre-processing solution may make use of both automatic parsing and user provided annotations. Furthermore, the pre-processing solution may utilize hotspots to associate pieces of media content and information to further enhance the readability of the document.

In one aspect, a computer-implemented method for pre-processing documents is provided. The method includes receiving, by a computing device, an initial document in digital format. The method includes detecting, by the computing device and based on a computerized analysis of the initial document, one or more attributes of the initial document, wherein the one or more attributes comprise a font detail or a vector graphics, or both. The method includes generating, by the computing device and based on the detected one or more attributes, a hierarchical structure associated with the initial document, the hierarchical structure interconnecting one or more components of the initial document. The method includes transforming, by the computing device and based on the hierarchical structure, the initial document to a modified document, wherein the modified document comprises one or more navigable links that facilitate computerized navigation of the hierarchical structure. The method includes providing, by the computing device, the modified document.

In a second aspect, a computing device for pre-processing documents is provided. The computing device includes one or more processors, a memory, and data storage. The data storage has stored thereon computer-executable instructions that, when executed by the one or more processors, cause the computing device to carry out functions. The functions include: receiving, by a computing device, an initial document in digital format; detecting, by the computing device and based on a computerized analysis of the initial document, one or more attributes of the initial document, wherein the one or more attributes comprise a font detail or a vector graphics, or both; generating, by the computing device and based on the detected one or more attributes, a hierarchical structure associated with the initial document, the hierarchical structure interconnecting one or more components of the initial document; transforming, by the computing device and based on the hierarchical structure, the initial document to a modified document, wherein the modified document comprises one or more navigable links that facilitate computerized navigation of the hierarchical structure; and providing, by the computing device, the modified document.

In a third aspect, a media sharing system for collaborative media content sharing is provided. The media sharing system includes one or more processors, one or more memories, and data storage, wherein the data storage has stored thereon computer-executable instructions that, when executed by the one or more processors, cause the one or more processors to carry out functions comprising: providing, by a computing device, a modified document comprising a hierarchical structure representing contents of an initial document in digital format, the hierarchical structure having been generated based on detected one or more attributes of the initial document, the one or more attributes comprising a font detail or a vector graphics, or both, and wherein the modified document comprises one or more navigable links that facilitate computerized navigation of the hierarchical structure; receiving a user indication to add a hotspot annotation to a portion of the modified document; annotating the portion of the modified document with the hotspot annotation; and sharing at least the annotated portion of the modified document over a social networking platform.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates an example document transformation process, in accordance with example embodiments.

FIG. 2 illustrates an example table of contents with a three-column layout and multiple headings in a user manual document, in accordance with example embodiments.

FIG. 3 illustrates an example section of a page in a user manual document, in accordance with example embodiments.

FIG. 4 illustrates another example section of a page in a user manual document, in accordance with example embodiments.

FIG. 5 is a flowchart illustrating a method of pre-processing a document, in accordance with example embodiments.

FIG. 6 illustrates an example image with callouts identified by a method to identify callouts in an image, in accordance with example embodiments.

FIG. 7A illustrates an example interactive graphical user interface in a first state, in accordance with example embodiments.

FIG. 7B illustrates an example interactive graphical user interface in a second state, in accordance with example embodiments.

FIG. 8 illustrates an example interactive graphical user interface for searching hierarchical information, in accordance with example embodiments.

FIG. 9 illustrates an example interactive graphical user interface for uploading a three-dimensional (3D) model, in accordance with example embodiments.

FIG. 10 illustrates an example interactive graphical user interface for displaying visual content and creating one or more hotspots as part of an example media sharing system for collaborative media content sharing, in accordance with example embodiments.

FIG. 11 illustrates an example interactive graphical user interface for viewing hotspots in visual content as part of an example media sharing system for collaborative media content sharing, in accordance with example embodiments.

FIG. 12 is a block diagram of a computing device, in accordance with example embodiments.

FIG. 13 depicts a distributed computing environment, in accordance with example embodiments.

FIG. 14 is a flowchart illustrating a method of pre-processing a document, in accordance with example embodiments.

### DETAILED DESCRIPTION

This application relates, in one aspect, to a document pre-processing system to transform the information, images, vector graphics, or raster graphics within a document into a hierarchical format that is navigable, searchable, and where the content can be highlighted based on relevance. As used herein, the term “vector graphics” generally refers to computer images defined by geometric shapes in two and/or or three dimensions.

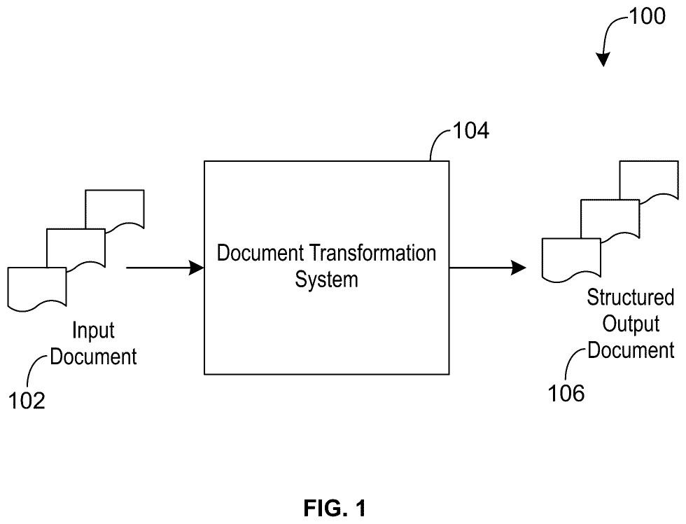

FIG. 1 illustrates an example document transformation process 100, in accordance with example embodiments. A document transformation system 104 may receive an input document 102 from a source. This source may be storage of the document transformation system 104, a camera or scanner, an external computing system, or the internet or another network connection. The input document 102 may be a user manual or other reference material. It may also be any other document containing human-readable information. The input document 102 may also be in various file formats, such as raw text data, a portable document format (PDF) file, an electronic publication (EPUB) file, or an image representation of the input document 102.

The document transformation system 104 may process the input document 102. The document transformation system 104 may detect, by a computing device, one or more attributes of the input document 102. These attributes may include, but are not limited to: structural information about a page of a document, table of contents (TOC) information about a document, semantic information about the information contained in a document, formatting information, such as text size, font, and color, of a document, and metadata associated with a document. The detection may be performed by a neural network, an optical character recognition (OCR) algorithm, or another method of text and image recognition.

Based on these detected attributes, the document transformation system may generate, by a computing device, a structured output document 106 according to a hierarchical structure. The structured output document 106 may be a modification of the input document 102 based on the detected attributes. The hierarchical structure of the structured output document 106 may be defined so that related information is structured to be more readable or more easily presentable to a user. For example, the hierarchical structure may interconnect one or more components of the initial document. The structured output document 106 may include one or more navigable links that facilitate computerized navigation of various components of the hierarchical structure. These components may represent information, images, video, vector graphics, raster graphics, annotation, or metadata related to or contained within the input document 102. The structured output document 106 may also be defined so that it is searchable or navigable. In some example embodiments, the structured output document 106 may also contain one or more callouts that emphasize, add context to, or modify information contained within the input document 102. The structured output document 106 may be displayed by a computing device, stored in memory or storage of a computing device, or provided to one or more users via a computing device or a network connection.

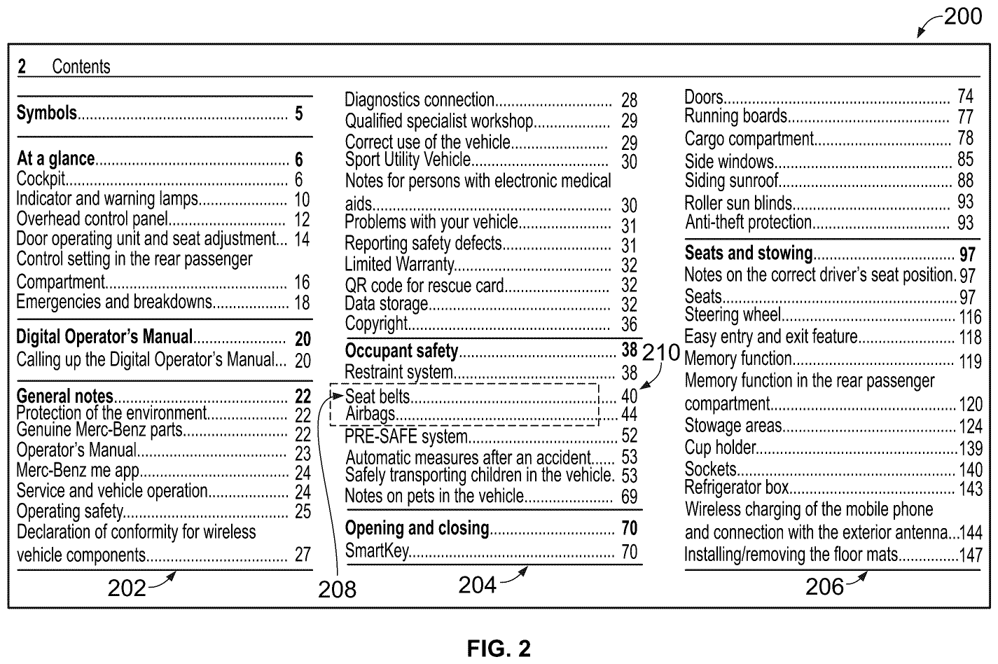

FIG. 2 illustrates an example table of contents section 200 from a user manual document, in accordance with example embodiments. The table of contents section 200 may be a page from a portable document format (PDF), an electronic publication (EPUB), or an image representation of a page of a document. In some aspects, the table of contents section 200 may be in a machine-readable text format. In other aspects, the table of contents section 200 may consist of multiple pages of a document. In other aspects, the table of contents section 200 may describe a document other than a user manual document. In an example embodiment, the table of contents section 200 may include media content in a column format, which may comprise a plurality of columns 202, 204, and 206. The plurality of columns 202, 204, and 206 may include one or more items of media content including but not limited to text, images, vector graphics, and/or video clips. The plurality of columns 202, 204, and 206 may also be presented horizontally side-to-side, vertically on top of one another, or in some combination of these layouts. For example, FIG. 2 illustrates the plurality of columns 202, 204, and 206 organized horizontally end-to-end. Furthermore, in some aspects, the plurality of columns 202, 204, and 206 may be of different sizes, as indicated by column 206, which is shorter vertically than columns 202 and 204.

In some example embodiments, the plurality of columns 202, 204, and 206 may include one or more sections of media content. For example, column 204 includes section 208 (indicated by a box with a dashed boundary). The text within section 208 indicates that media content relating to seatbelt and airbag systems of a vehicle described in a user manual document is available at pages 40 and 44 respectively. The media content of the sections may be text, images, vector graphics, video clips, or callouts to associated images and vector graphics. Furthermore, the media content of the sections may be divided further into subsections. In some aspects, the media content of the sections may further be divided across pages or placed on different portions of the page while still being included under the section. For example, the media content of section 208 includes, but is not limited to, text describing a topic and associated page numbers that indicate portions of the user manual document that contain information related to the topic. For example, the media content item 210 is a line of text that describes how the “Airbags” section of the manual may begin at, or be located on, page 44. The topic description of the media content item 210 may be, but is not limited to being, text, images, vector graphics, video clips, or callouts to associated images and vector graphics. Furthermore, the page number of the media content item 210 may be, but is not limited to being, a page number associated with an actual page, a placeholder, a location indicator that indicates a location in a digital file, a paragraph number, a text line number, or a hyperlink. The page number of the media content item 210 may also not be in the media content item 210.

The table of contents section 200 illustrated in FIG. 2 may be used to construct a virtual representation of the table of contents section 200 of the user manual document. In some embodiments, such a virtual representation of the table of contents section 200 of the user manual document may be formatted in a hierarchical format. The document transformation system 104 may identify, for example, by an optical character recognition (OCR) algorithm, the pages of the user manual document that correspond to the table of contents section 200. Such pages may follow a shared format, or be marked explicitly as the table of contents for the document. The document transformation system 104 may then identify the sections, headers, corresponding page numbers, and/or other relevant parts of the document. Such document characteristics may be identified in several ways, including applying an OCR algorithm, processing text, images, and/or drawings to identify additional features such as font details and vector graphics. The sections, headers, corresponding page numbers, etc. may be identified by any one or any combination of the following features of the text including but not limited to: text contents, text size, font, color, styles (for example, bold, italics, underline), indentation, numbering, text position, line spacing, and so forth. The sections, headers, corresponding page numbers, etc. may also be identified based on the metadata of the user manual document. The system may also identify the sections, headers, corresponding page numbers, etc. based on hyperlinks within the user manual document

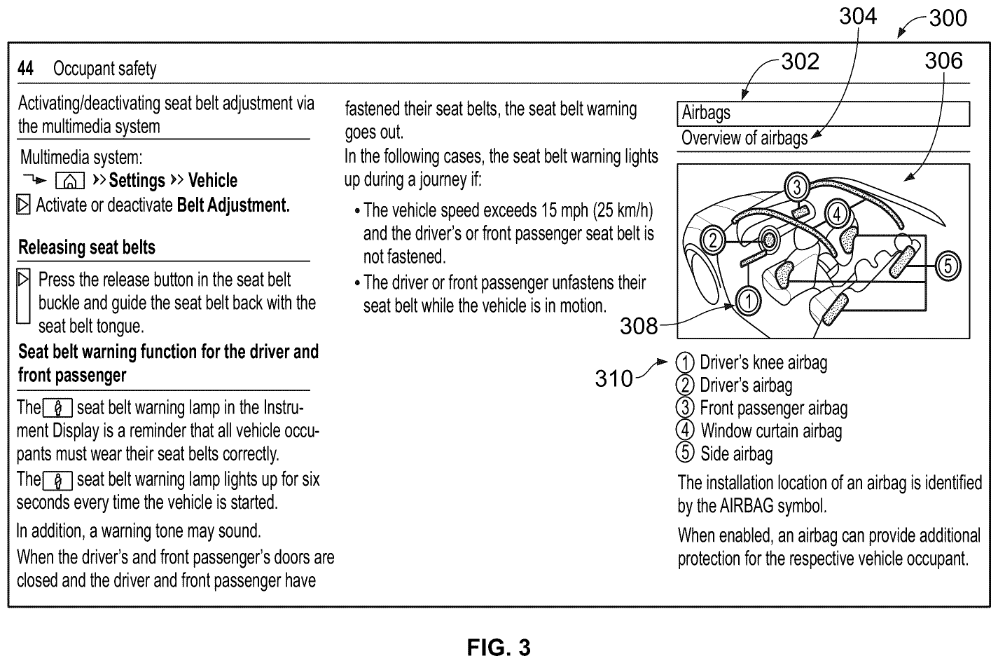

FIG. 3 illustrates an example section 300 of a user manual document, in accordance with example embodiments. The section 300 may be a page from a PDF, an EPUB, or an image representation of a page of a document. In some aspects, section 300 may be in a machine-readable text format. In other aspects, section 300 may consist of multiple pages of a document. In other aspects, section 300 may be a part of a document other than a user manual document. In an example embodiment, section 300 may include media content in a column format. The columns may include one or more items of media content including but not limited to text, images, vector graphics, and/or video clips. The columns may also be organized horizontally side-to-side, vertically on top of one another, or in some combination of these layouts. Furthermore, in some aspects, the columns may be different sizes.

In some example embodiments, section 300 may include one or more subsection headers. The subsection headers may be placed within a column, at the top of a column, or elsewhere within section 300. The subsection headers may comprise text, images, vector graphics, video clips, or slideshows. In some aspects, the subsection headers may be associated with a particular subsection of media content items contained within the subsection. For example, subsection header 302 describes and marks the location of the “Airbags” subsection of section 300. The “Airbags” subsection includes one or more media content items, including but not limited to text content, an image 306 with callouts, such as callout 308, and text 310 associated with callout 308.

The “Airbags” subsection may also include further subsections at various “levels.” For example, the level 2 subsection header 304 introduces the “Overview of airbags” level 2 subsection of the “Airbags” level 1 subsection. In some example embodiments, a subsection may have no additional subsections contained within it, or it may have any number of additional subsections, which may, in turn, each have any number of subsections contained within them. A subsection may include one or more media content items, which may include, but are not limited to, text, images, vector graphics, video clips, slideshows, callouts, and hyperlinks. For example, the level 2 “Overview of airbags” subsection introduced by the level 2 subsection header 304 contains the image 306 with callouts, the callout 308, and the text 310 associated with the callouts 308 in image 306. These media content items (e.g., image 306 and callout 308) are associated with both the section 300, the level 1 “Airbags” subsection 302, and the level 2 “Overview of airbags” subsection header 304.

The section 300 may also include visual media content items including, but not limited to, images, vector graphics, video clips, and slideshows. The visual media content items may be included within a column of the section 300, or elsewhere in the section 300. For example, the image with callouts 308 may contain one or more callouts that highlight, annotate, or add information to portions of the image with callouts 308. The one or more callouts may be placed anywhere within the image or vector graphic, and they may each contain one or more media content items. A callout may also be associated with one or more media content items in section 300 that adds further information, identifies the callout, or associates a media content item with the callout. Callouts may be associated with one or more media content items by a visual cue such as a number or shared color, a hyperlink, a physical cue such as an arrow, line or shared symbol, or text describing the association between the callout and the one or more media content items. For example, the callout 308 is numbered “1,” associating it with the text 310 describing the callout 308, which is also numbered “1.”

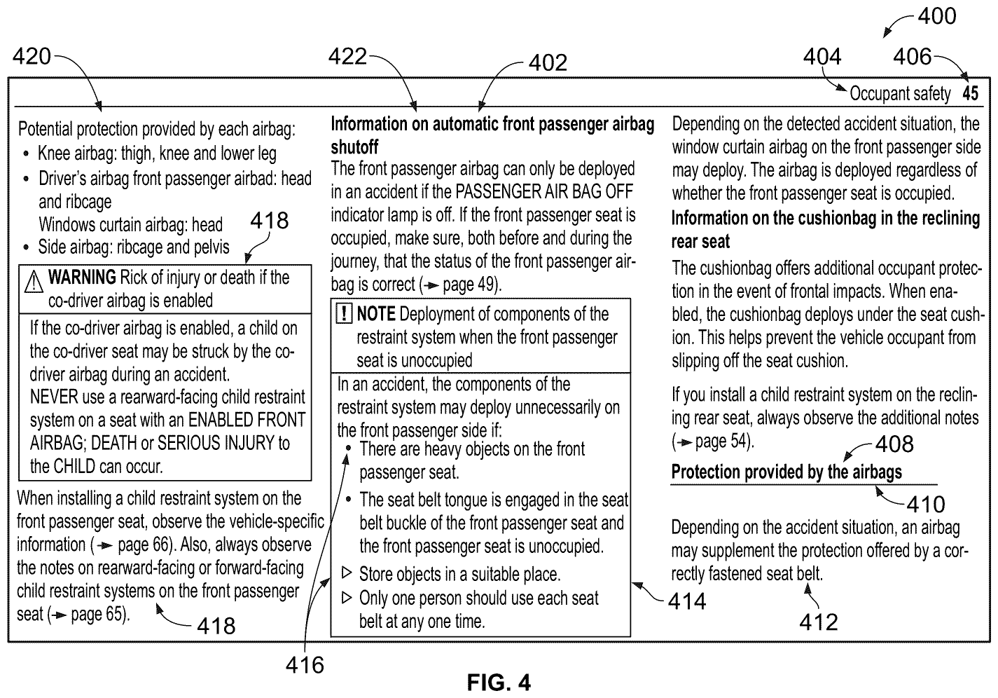

FIG. 4 illustrates another example of a section 400 of a user manual document. FIG. 4 may share one or more aspects in common with FIG. 3. In this example, section 400 consists of three columns, for example, including second column 414, that each contain text media content items. The section 400 is also divided into a number of subsections demarcated by level 1 subsection header 408, and the level 2 subsection headers, for example the level 2 subsection header 402. Each level of subsection header may be differentiated by their font, style, size, and color. For example the level 1 subsection header 408 has font, style, size, and color 410, which is different from the level 2 subsection header 402 having font, style, size and color 422. Also, for example, position of the text in the line, as well as any vector graphics information available for that area may be utilized. Font, style, size, and color 410 includes blue text, and has an underline, while font, style, size, and color 422 includes black text that is not underlined. Other differences in font, style, size, and color are possible. Additionally, and/or alternatively, part-of-speech (POS) tagging and line spacing may also be used as input features. The document pre-processing system (e.g., document transformation system 104) may use these differences in font, style, size, color, and other text or media content item features to differentiate between different levels of subsection headers and generate a hierarchical data structure to represent the information contained within the section 400.

Differences in font, style, size, and/or color may also be used to differentiate between different types of text within the media content items. For example, the paragraph font, style, size, and color 412 may be used to differentiate the paragraph text from the bullet points 416. In some embodiments, vector graphics that intersect a bounding box of an image may be identified. The document preprocessing system may use these data to further differentiate information and media content items within the hierarchical data structure representing the section 400, and/or it may use them to associate the media content items with other media content items. For example each of the bullet points in the group of bullet points 416 may be associated with different topics, subsections, or other media content items. They may also be presented to the user in a different format by the document pre-processing system.

Other features of the page layout of the section 400 may be identified and used by the document pre-processing system to create the hierarchical data structure representing the section 400. Common page layout features such as page number, tables, images, vector graphics, and formatting elements may be used by the document pre-processing system (e.g., document transformation system 104). For example, the page number 406 may be used to associate information gathered across different pages of the document. Furthermore, the page number 406 may be used alongside the data collected by the document preprocessing system from the table of contents section 200 of the document. Similarly, the section header text 404 and the page header demarker 420 may be used by the document pre-processing system. For example, the position of the page header demarker 420 may be used to demarcate where a section header is on a page of the document in relation to the media content items. It may also be used to demarcate sections of the text into subsections at various levels.

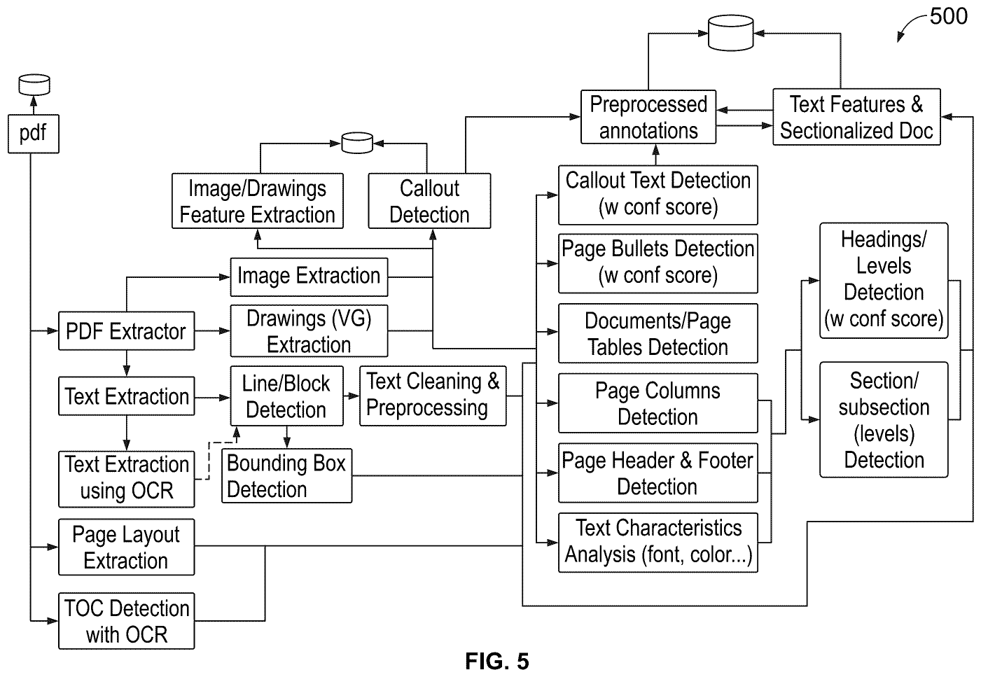

FIG. 5 is a flowchart illustrating a method of pre-processing a document, in accordance with example embodiments. FIG. 5 provides a high-level overview of a method 500 of pre-processing a PDF document, including various potential steps of the document pre-processing method. The use of a PDF file is merely used as an example embodiment of the method 500, and other document formats may be used. At the beginning of the method 500, the PDF document will be extracted by a PDF extractor. This PDF extractor may be one of many open-source PDF extractors, or a proprietary program. The PDF extractor may perform text extraction, which may involve the use of an OCR algorithm to extract the text of the document. Furthermore, the PDF extractor may also use a machine learning (ML) or neural network algorithm to perform text extraction.

The PDF extractor may also perform page layout extraction and table of contents (TOC) detection. The page layout extraction may involve using OCR or ML algorithms to identify the layout of pages of the PDF document, including data such as the number of columns, section and subsection information, and image layout. The table of contents detection may involve extracting page layout and text information from a table of contents similar to the table of contents section 200 illustrated in FIG. 1, or it may include using data from the metadata of the PDF document. The table of contents information may be used to inform the further pre-processing of the PDF document, as well as the construction of the hierarchical data structure to represent the information within the PDF document.

Image, drawing, line/block, and bounding box extraction and detection may be performed on the PDF document. Image extraction, drawing extraction and image feature extraction may include identifying images and vector graphics used in the PDF document. It may further include pre-processing the images and vector graphics to identify features of the images and vector graphics. For example, image feature detection techniques and ML algorithms may be used to detect lines, identify callouts, associate image callouts or information with other media content items, or associate images and vector graphics with sections and subsections of the PDF document or its table of contents information. Drawing extraction may also involve extracting information from vector graphics files to identify features and associate media content items with features and callouts in the vector graphics files. Line, block, and bounding box detection may involve the use of OCR and/or ML algorithms to further identify the layout of pages of the PDF document.

Callout detection may also be performed by the method 500. Callout detection may utilize the data gathered from the text extraction, image extraction, and drawings extraction process illustrated in FIG. 5 to identify callouts and associated text. Callout detection may further include the use of callout text detection to identify text labeling the callouts themselves, and any text associated with the callouts. Furthermore, callout detection may include the extraction and utilization of layout information such as page bullets, page tables, columns, header and footer, headings, and section/subsection information. Text characteristic information may also be used to inform callout detection. Text characteristics may include, but are not limited to: font, font size, color, font style, and font line weight.

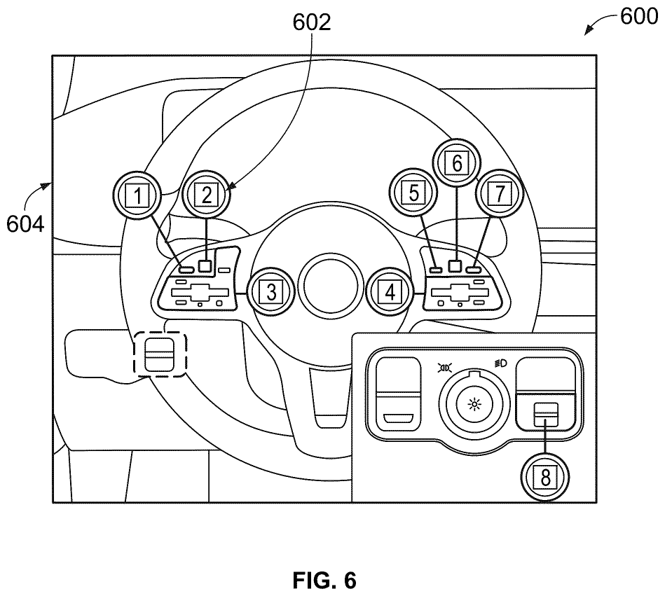

FIG. 6 illustrates an example image 600 with callouts identified by a method to identify callouts in an image, in accordance with example embodiments. The image 600 may include one or more callouts that highlight, annotate, or add information to portions of the image 600. A callout may also be associated with media content items that also add further information, identify the callout, or associate a media content item with the callout. Callouts may be associated with one or more media content items by a visual cue such as a number or shared color, a hyperlink, a physical cue such as an arrow, line or shared symbol, or text describing the association between the callout and the one or more media content items. For example, the callout 602 is numbered “2.” It may be associated with a corresponding media content item in the document also labeled “2.” The document preprocessing system makes use of this label to create an association linking the callout 602 to its associated media content item in the hierarchical data structure representing the information within the document.

In some embodiments, the callouts of the image 600 may be difficult to identify or difficult to distinguish from other lines and annotations in the image 600. The document preprocessing system may divide the image 600 into one or more tiles. The document pre-processing system may also use line detection and proximity detection with respect to the one or more tiles of the image 600 to detect lines within the image and identify which lines may be associated with a callout.

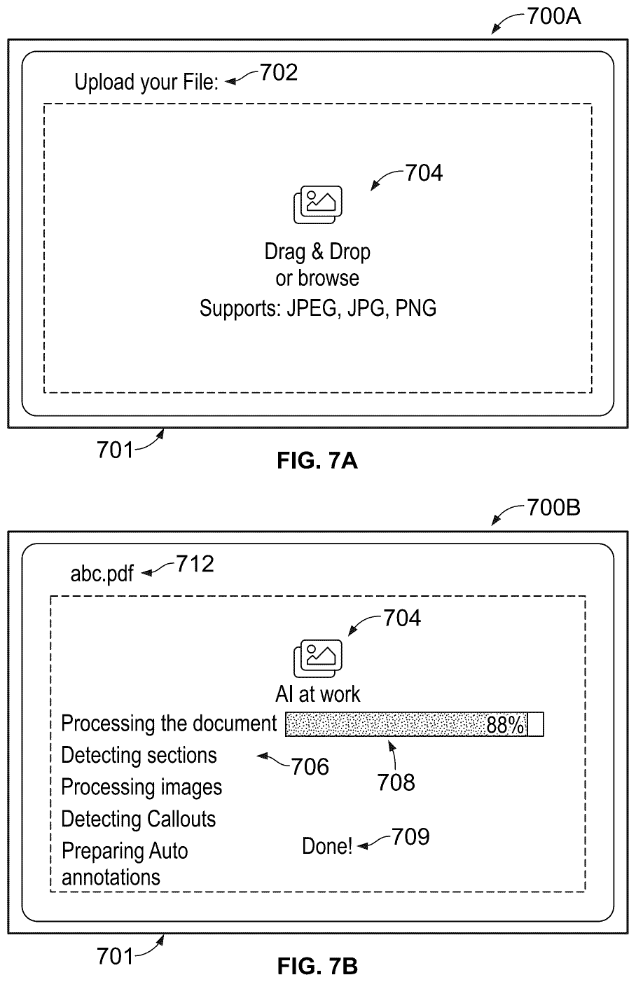

FIG. 7A illustrates an example interactive graphical user interface 700A in a first state, in accordance with example embodiments. Computing device 700 can include an interactive graphical user interface (GUI) that displays the GUI 701. The GUI 701 may include a title or instructions 702, and a file drop or selection widget 604. The file drop or selection widget 604 may be a visual icon, a text instruction, a button, or another user interface element that allows the user to select a file.

A user of computing device 700 may wish to pre-process an image or document to enhance its readability and/or to transform the information within the image or document into a hierarchical format. The user may initiate this pre-processing on computing device 700 by using the file drop or selection widget 704 to drop or select an image or document file to pre-process. In some aspects, the user may be able to use a mouse, touch screen, or other input/output device connected to the computing device 700 to select a file and “drop” it into the file drop or selection widget 704. The user may also be able to select the file drop or selection widget 604 and initiate a file selection process. The file selection process may include opening a file browser of the computing device 700 or an application of the computing device 700 that allows the user to select one or more files.

In some aspects, the one or more selected files may be captured by an image capturing device of computing device 700. In another aspect, the one or more selected files may be extracted from a document file stored on computing device 700. Also, for example, the one or more selected files can be an image stored in computing device 700. As another example, the one or more selected files can be shared by another user, for example, over a shared media platform or via a wired or wireless network connection.

FIG. 7B illustrates an example interactive graphical user interface 700B in a second state, in accordance with example embodiments. FIG. 7B shares one or more aspects in common with FIG. 7A. In this example, the user has selected one or more files using the file drop or selection widget 704. This indicates to the computing device 700 that the user wishes to begin the pre-processing of the one or more selected files on the computing device 700. Accordingly, the instructions 702 of FIG. 7A has changed to represent the filename 712 “abc.pdf” of the selected one or more files. Likewise, the GUI 701 of FIG. 7A has been configured to display, responsive to the selection of one or more files by the user and the initiation of the document pre-processing, progress indicator categories 706, as shown in GUI 701 of FIG. 7B. The progress indicator categories 706 may include various steps of the pre-processing method, including in this example but not limited to: “processing the document,” “detecting sections,” “processing images,” “detecting callouts,” and “preparing auto annotations.” The progress indicator categories 706 may be representative of the actual steps being taken by the pre-processing method, or they may be abstractions meant to convey a sense of progress to the user. Furthermore, the progress indicator categories 706 may be omitted from the GUI 701. In some embodiments, the GUI 701 may also include one or more progress bars associated with the progress indicator categories 706. The progress bars may be fillable bars, segmented graphics, rotating wheels, or other symbols, animations, or user interface elements commonly used to denote a process of computing device 700 in progress. For example, progress bar 708 is associated with the “Processing the document” progress indicator category of progress indicator categories 706. The progress bar 708 is initially “empty,” which may be indicated by visual contrast elements on the body of the bar such as coloration or texture. The computing device 700 may then cause the GUI 701 to “fill” the progress bar to indicate the completion of a progress indicator category from the set of one or more progress indicator categories 706. Furthermore, the progress bars may be representative of the actual completion of a task by the computing device 700, or they may be abstractions meant to convey a sense of progress to the user.

In some embodiments, upon completion of the pre-processing method by the computing device 700, the GUI 701 may also display a termination message 709. The termination message 709 may comprise text, an image, a vector graphic, a symbol, an animation, or a video clip, and may indicate that the document has successfully pre-processed. The termination message 709 may also present the user with a user interface element that allows the user to view or download the pre-processed hierarchical data structure from the document, or it may initiate a viewing or downloading procedure.

In some embodiments, a trained machine learning model may be used to detect the one or more attributes in a document. The trained machine learning model may include artificial neural networks (e.g., convolutional neural networks, recurrent neural networks, a Bayesian network, a hidden Markov model, a Markov decision process, a logistic regression function, a support vector machine, a statistical machine learning algorithm, and/or a heuristic machine learning system). The trained machine learning model may be based on machine learning algorithms. For example, classification algorithms may be used to classify various attributes of the document. Classification algorithms used herein may include one or more of support vector machines, K-nearest neighbors algorithms, Logistic regression, random forest algorithms, binary classification, multiclass classification, K-means clustering, linear classifiers, non-linear classifiers, multi-label classification, sentiment classifier, Naive Bayesian classifier, Decision Trees, and so forth.

In some embodiments, Natural Language Processing (NLP) may be used. For example, POS tagging may be used to add additional context and labels to the document. In some embodiments, Natural Language Generation (NLG) may be used to add labels, captions (e.g., automatic image captioning), metadata, and other information to the document. Also, for example, sentiment analysis may be performed on the document to identify additional information content and/or relevance of a portion to the overall document.

Training of the machine learning models may involve generating training data comprising a pair of input data (e.g., a document) and labeled data (e.g., structured version of the document). For example, the structured version of the document may include font details, vector graphics, raster graphics, structural attributes, content attributes, and/or other relevant parts of the document. Such training data may be input to a machine learning model and the machine learning model can be trained to receive an input document and output a structured document. The training may involve supervised, unsupervised, semi-supervised, and/or reinforcement learning techniques. In some embodiments, a generative adversarial network (GAN) may be used to train the machine learning model on the training data.

Also, for example, the training may involve one or more loss functions such as a mean squared error, a mean absolute error, categorical cross-entropy loss for multi-class classification of document attributes (e.g., for classification algorithms), an adversarial loss (e.g., for a GAN), and so forth. Techniques to minimize loss may include a gradient descent algorithm.

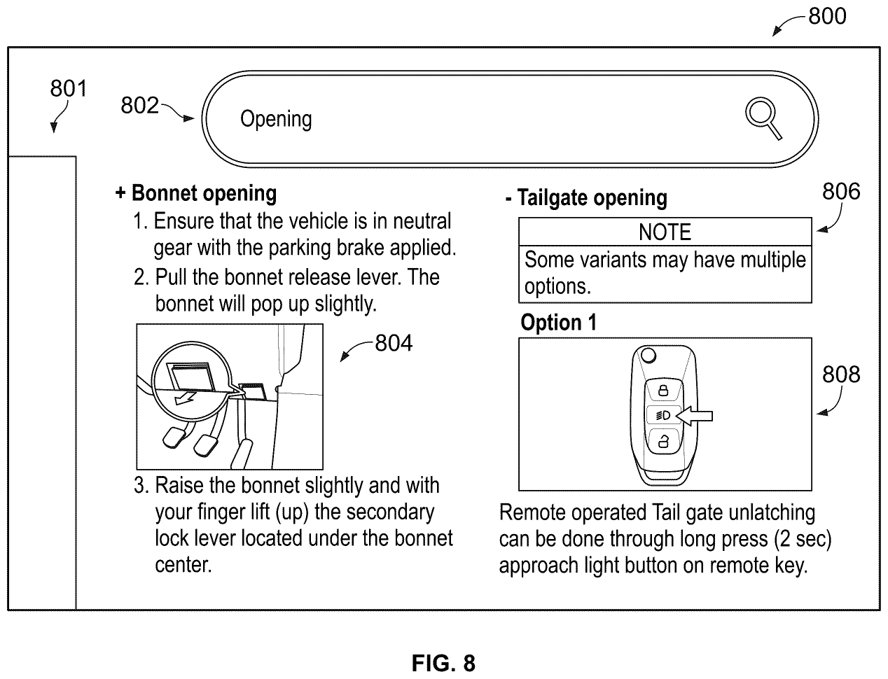

FIG. 8 illustrates an example interactive graphical user interface for searching hierarchical information, in accordance with example embodiments. Computing device 800 can include an interactive GUI that displays the GUI 801. The GUI 801 may include a search bar 802 that allows for the user to input search queries and terms. The search bar 802 may allow for user text input from an input/output device such as a keyboard or touch screen, or it may be a drop-down menu with various search categories. Responsive to the query input by the user into the search bar 802, the GUI 801 may also include one or more search results, wherein the one or more search results may be sections, subsections, or media content items of the pre-processed hierarchical data structure of a document. The search results displayed by the GUI 801 may be selected based on the search results input into the search bar 802. The search results may be selected based on their section, subsection, caption, or callout titles containing terms included or related to the search query. For example, the search result 804 is a subsection titled “bonnet opening,” which may be a subsection located in some portion of the document. It has been selected from the hierarchical data structure representing the document based on the term “opening” being entered into the search bar 802. Likewise, the similar “tailgate opening” search result 806 has been selected based on the term entered into the search bar 802. The search results 804 and 806 may comprise media content items including but not limited to: text, images, vector graphics, video clips, slideshows, and hyperlinks.

In some embodiments, the media content items included within search results 804 and 806 may comprise media content items including but not limited to: text, images, vector graphics, video clips, slideshows, and hyperlinks. For example, the image 808 in the “tailgate opening” search result 806 illustrates a key of the vehicle described in the user manual document, with a callout noting the location of a button on the key. In some embodiments, the image 808 may include instructional content such as an image or video tutorial, alongside user comments on the instructional material.

In some embodiments, users may be able to annotate and suggest search results related to a particular term or topic entered into search bar 802. For example, a user may enter the search term “opening” into search bar 802, but be unable to find the section, subsection, or media content item of the manual that they intended. In that situation, the user may be able to locate the section, subsection, or media content item they desired and manually note that it relates to the search term input into search bar 802. Future searches of that search term would subsequently also return the annotated content.

In some embodiments, the searching and annotation of search results and information within the hierarchical data structure representing the information contained within a document may be performed by “content creators.” Such content creators may be third-parties, consumers, or individuals associated with the publisher or host of the pre-processed document. A content creator may be able to further edit, annotate, and arrange the media content items within the hierarchical data structure representing the information within a document. For example, a content creator may annotate information within the hierarchical data structure such that it is associated with certain searches in the search bar 802. Furthermore, a content creator may be able to add additional information into the hierarchical data structure. In search result 806, for example, a content creator may decide that the included image 808 is insufficient to describe the “tailgate opening” features. Therefore, the content creator may decide to add additional media content items to further describe the operations described in the search result 806. These additional media content items may comprise, but are not limited to: text, images, vector graphics, video clips, slideshows, and hyperlinks. The additional media content items may also be created by the content creator or sourced from the internet or another source.

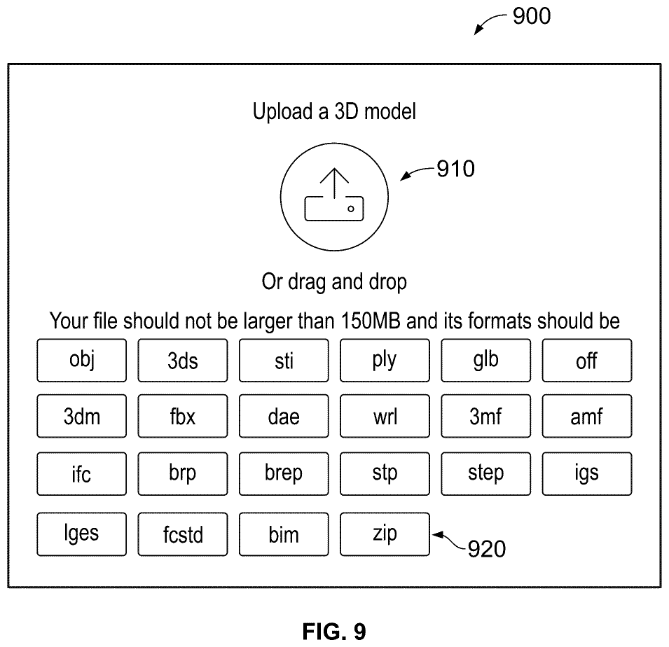

FIG. 9 illustrates an example interactive graphical user interface for uploading a 3D model, in accordance with example embodiments. The GUI 900 may include one or more file drop icons 910 that instruct a user to upload a file. The file may be a three-dimensional (3D) model file in one of various formats 920 displayed by the GUI 900. The file may also be a bitmapped image, a vector image, a video clip, an audio clip, or other media content item. The user may also upload multiple files using the GUI.

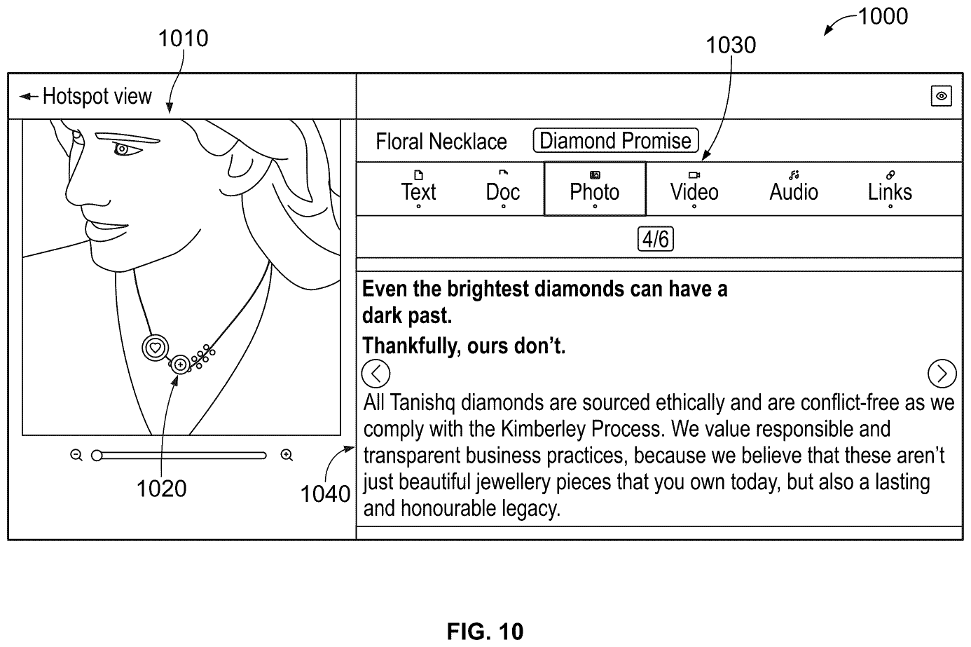

FIG. 10 illustrates an example interactive graphical user interface 1000 for displaying visual content and creating one or more hotspots as part of an example media sharing system for collaborative media content sharing, in accordance with example embodiments. The GUI 1000 can display one or more media content items 1010. In FIG. 10, the example media content item 1010 is an image. The media content item 1010 may include one or more hotspots such as hotspot 1020. These hotspots may highlight or annotate certain defined sections of the media content item 1010, or they may apply to the media content item 1010 as a whole.

The hotspot 1020 may be created by the user. In this case, the user would select the media content item 1010 or a certain section of the media content item 1010 and create a hotspot. A document preprocessing system may also create the hotspot 1020 after pre-processing a manual, documentation, or other document related to the media content item 1010. Other users may also create the hotspot 1020 through a social media or other online platform. In this case, the other users may create hotspots on the media content item 1010, annotate and describe the hotspots, and make the hotspots viewable by the public on social media or other online platforms. Likewise, a user may be able to share hotspots with specific users on social media or other online platforms. Hotspots created by users on social media or other online platforms may also include ratings by the user, such as a like counter or percentage quality rating. These ratings may affect the visibility of the hotspots to users of the social media or other platform, alongside other qualities of the hotspots.

The hotspot 1020 may also include associated information. The information may be displayed by the GUI 1000 as one of many formats selectable by a format selector widget 1030. The format selector widget 1030 may have categories such as “text,” “doc,” “photo,” “video,” “audio,” and “links.” In this way, the hotspot 1020 may be associated with one or more media content items such as the photo 1040. The photo 1040 shows an example screenshot of a text description of the media content item 1010. The one or more media content items associated with the media content item 1010 may be uploaded by the user, generated by a document pre-processing system, or uploaded by users of a social media or other online platform. The one or more media content items may also be edited and rated in similar ways.

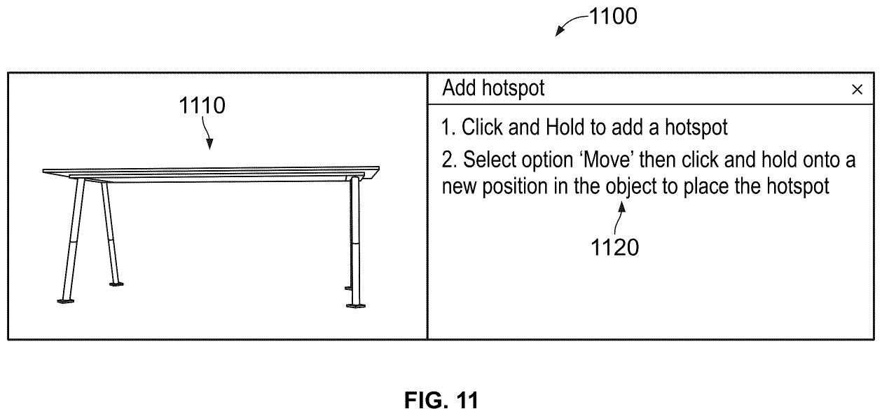

FIG. 11 illustrates an example interactive graphical user interface 1100 for viewing hotspots in visual content as part of an example media sharing system for collaborative media content sharing, in accordance with example embodiments. The GUI 1100 may display media content items such as the 3D model 1110. The 3D model 1110 may have been uploaded by a GUI similar to the GUI 900 illustrated in FIG. 9. It may also be generated by a document pre-processing system. The 3D model 1110 may also be sourced from a social media or other online content platform. The GUI 1100 may also display instructions 1120 that instruct a user how to add a hotspot to the 3D model 1110. The user may then add one or more hotspots to the 3D model 1110. The one or more hotspots may be associated with one or more media content items describing and annotating the hotspots to add more context or information to the 3D model 1110. The 3D model 1110 as annotated with hotspots may then be uploaded to a social media or other online platform.

Generally, one or more of the graphical user interfaces described herein may be available as a platform, as an application programming interface (API), an application-specific integrated circuit (ASIC), as a service (e.g., Software as a Service (SaaS), Machine Learning as a Service (MLaaS), Analytics as a Service (AnaaS), Platform as a Service (PaaS), Knowledge as a Service (KaaS), and so forth.

### Example Computing Device

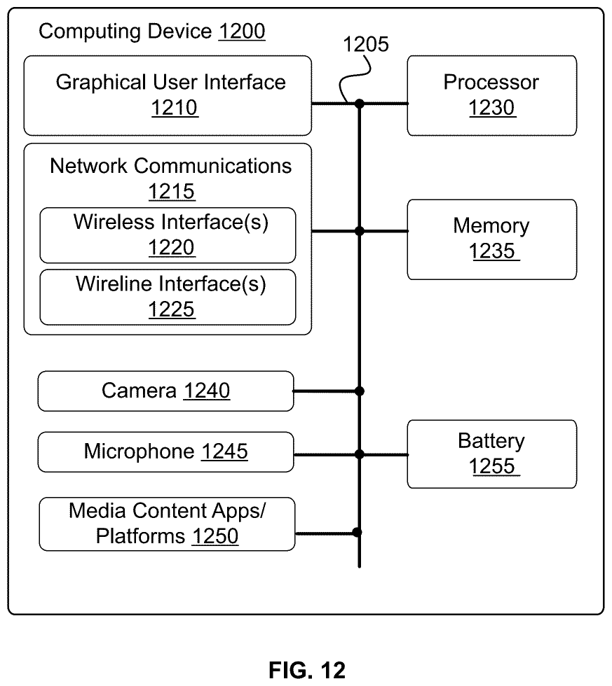

FIG. 12 is a block diagram of an example computing device 1200, in accordance with example embodiments. In particular, computing device 1200 shown in FIG. 12 can be configured to perform at least one function of method 1400.

Computing device 1200 may include modules to provide various functionalities, such as for example, a graphical user interface 1210, network communications 1215, a processor 1230, memory 1235, a camera 1240, a microphone 1245, and battery 1255, all of which may be linked together via a system bus, or other connection mechanism 1205.

Graphical user interface 1210 can be configured to send data to and/or receive data from external user input/output devices such as a touch screen, a computer mouse, a keyboard, a microphone, external monitors, and the like. Graphical user interface 1210 can also be configured to generate audio and/or video outputs.

Network communications 1215 can be configured to provide one or more wireless interface(s) 1220 and/or one or more wireline interface(s) 1225 that can be configured to communicate via a network. Wireless interface(s) 1220 can include wireless transmitters, receivers, and/or transceivers (e.g., for Bluetooth, Wi-Fi, near-field communications, etc.). Wireline interface(s) 1225 can include wireline transmitters, receivers, and/or transceivers (e.g., Ethernet transceiver).

In some examples, network communications 1215 can be configured to provide reliable, secured, and/or authenticated communications. For example, network communications 1215 can be configured to provide encrypted data. The type of encryption may depend on a type of network interface, capabilities of a network itself, a type of data to be transmitted, and so forth.

Processor 1230 can include a general purpose processor, and/or special purpose processors (e.g., digital signal processors, graphics processing units (GPUs), media processing processors, image processing processors, text processing processors, speech processing processors, etc.). Processor 1230 can be configured to execute computer-readable instructions that are contained in memory 1235 and/or other instructions as described herein.

Memory 1235 can include one or more non-transitory computer-readable storage media that can be read and/or accessed by processor 1230. The one or more computer-readable storage media can include volatile and/or non-volatile storage components. In some examples, memory 1235 can be implemented using a single physical device, while in other examples, memory 1235 can be implemented using multiple physical devices.

Memory 1235 can include computer-readable instructions that, when executed by processor 1230, enable computing device 1200 to provide for some or all of the functionality of the computing devices and/or document pre-processing platforms described herein.

The functions include: receiving, by a computing device, an initial document in digital format; detecting, by the computing device and based on a computerized analysis of the initial document, one or more attributes of the initial document, wherein the one or more attributes comprise a font detail or a vector graphics, or both; generating, by the computing device and based on the detected one or more attributes, a hierarchical structure associated with the initial document, the hierarchical structure interconnecting one or more components of the initial document; transforming, by the computing device and based on the hierarchical structure, the initial document to a modified document, wherein the modified document comprises one or more navigable links that facilitate computerized navigation of the hierarchical structure; and providing, by the computing device, the modified document.

In some embodiments, the one or more attributes includes the font detail comprising at least one of: a type of font, a font size, or a font color.

In some embodiments, the one or more attributes includes the vector graphics, and wherein the detecting of the vector graphics comprises detecting a vector graphic intersecting a bounding box of an image in the initial document.

In some embodiments, the one or more attributes comprise one or more structural attributes.

In some embodiments, the one or more attributes comprise one or more content attributes.

In some embodiments, the detecting of the one or more attributes includes performing an optical character recognition.

In some embodiments, the detecting of the one or more attributes includes applying a trained machine learning model.

In some embodiments, the initial document may be in a portable document format (PDF), and wherein the detecting of the one or more attributes involves applying a PDF extractor.

In some embodiments, the functions involve receiving a user indication to add a hotspot annotation to a portion of the modified document. In such embodiments, the functions also involve annotating the portion of the modified document with the hotspot annotation.

In some examples, computing device 1200 can include camera 1240. Camera 1240 can include still and/or video cameras.

In some examples, computing device 1200 can include microphone 1245. Microphone 1245 can be configured to capture audio inputs (e.g., speech, music, and so forth).

In some examples, computing device 1200 can include media content apps/platforms 1250. Media content apps/platforms 1250 may be configured to share media content, enable recording or playback of shared media content, create and/or share annotated images as described herein.

Battery 1255 may be configured to provide electrical power to computing device 1200. Each battery can, when electrically coupled to the computing device 1200, act as a source of stored electrical power for computing device 1200. Battery 1255 may be portable, removable, rechargeable, etc. The term battery is generally used herein to denote a power supply (wired or otherwise).

### Example Data Network

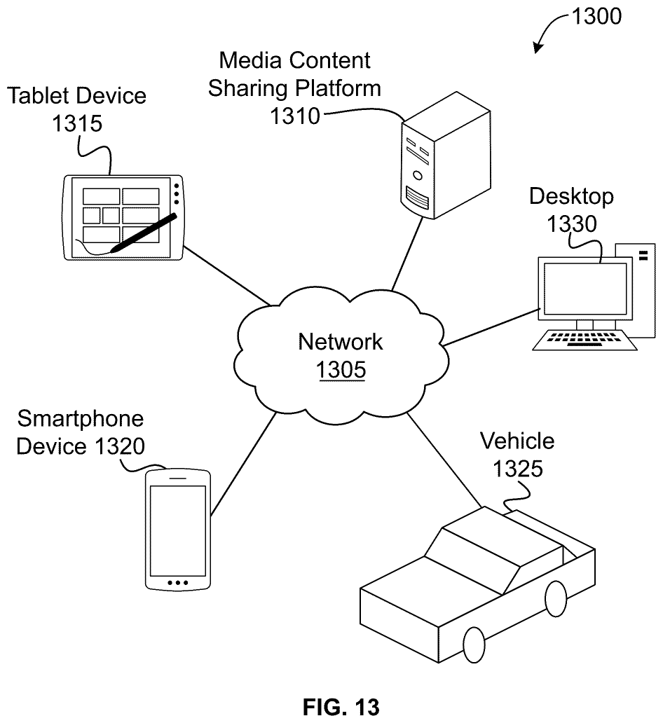

FIG. 13 depicts a distributed computing environment 1300, in accordance with example embodiments. Distributed computing environment 1300 includes a media content sharing platform 1310 (e.g., a server device, a distributed system, a hybrid cloud, a cloud server, and so forth) that is configured to communicate, via network 1305, with one or more computing devices, such as a tablet device 1315, a smartphone device 1320, a vehicle 1325 equipped with a computing device, and a desktop. Network 1305 may correspond to a local area network (LAN), a wide area network (WAN), a WLAN, a WWAN, an intranet, a public Internet, or any other type of network configured to provide a communications path between networked computing devices. Network 1305 may also correspond to a combination of one or more networks.

It may be noted that these devices shown are for illustrative purposes only. Generally speaking, media content sharing platform 1310 may be communicatively linked to a computing device over network 1305. In fact, it may be linked to multiple computing devices (e.g., millions) in a distributed computing environment 1300. In addition to the computing devices illustrated in FIG. 13, other devices such as mobile computing devices, wearable devices, head-mountable devices (HMD), AR devices, VR devices, aircrafts, boats, drones, and so on are possible. The devices may be directly connected to network 1305, or may be indirectly connected to network 1305 via another device that is directly connected.

### Example Methods of Operation

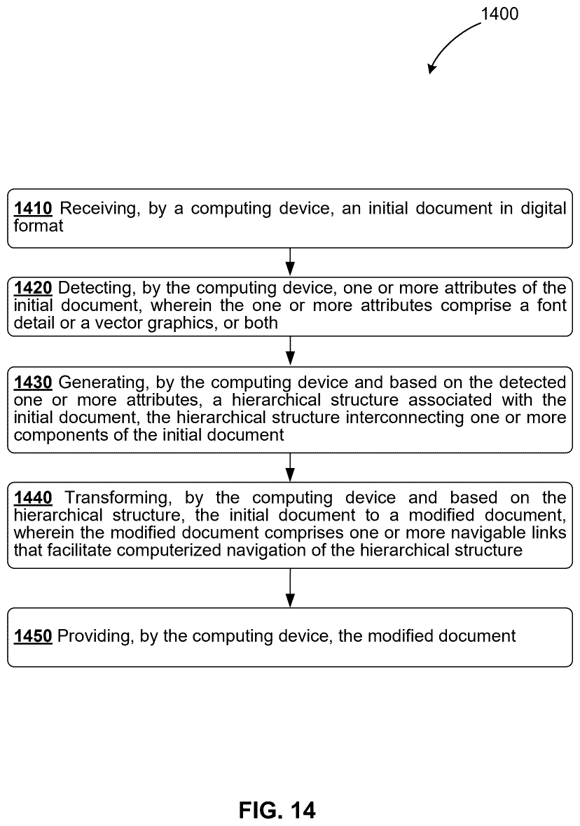

FIG. 14 is a flowchart illustrating a method of pre-processing a document, in accordance with example embodiments. Method 1400 can be executed by a computing device, such as computing device 1200. Method 1400 can begin at block 1410, wherein the method 1400 involves receiving, by the computing device 1200, an initial document in digital format.

At block 1420, the method 1400 involves detecting, by the computing device and based on a computerized analysis of the initial document 1200, one or more attributes of the initial document, wherein the one or more attributes comprise a font detail or a vector graphics, or both.

At block 1430, the method 1400 involves generating, by the computing device 1200 and based on the detected one or more attributes, a hierarchical structure associated with the initial document, the hierarchical structure interconnecting one or more components of the initial document.

At block 1440, the method 1400 involves transforming, by the computing device 1200 and based on the hierarchical structure, the initial document to a modified document, wherein the modified document comprises one or more navigable links that facilitate computerized navigation of the hierarchical structure.

At block 1450, the method 1400 involves providing, by the computing device 1200, the modified document.

In some embodiments, the one or more attributes includes the font detail comprising at least one of: a type of font, a font size, or a font color.

In some embodiments, the one or more attributes includes the vector graphics, and wherein the detecting of the vector graphics comprises detecting a vector graphic intersecting a bounding box of an image in the initial document.

In some embodiments, the one or more attributes comprise one or more structural attributes.

In some embodiments, the one or more structural attributes includes at least one of: a page attribute, a type of numbering, a line spacing, a callout, a hyperlink, header information, footer information, section information, column structure, page layout, a paragraph layout, position of a text in a line, or part-of-speech (POS) information.

In some embodiments, the one or more attributes comprise one or more content attributes.

In some embodiments, the one or more content attributes includes at least one of: image content, video content, textual content, or audio content.

In some embodiments, the detecting of the one or more attributes includes performing an optical character recognition.

In some embodiments, the detecting of the one or more attributes includes applying a trained machine learning model.

In some embodiments, the initial document may be in a portable document format (PDF), and wherein the detecting of the one or more attributes involves applying a PDF extractor.

In some embodiments, the computing device includes a user interface configured with a file drop or a selection widget for uploading one or more documents. In such embodiments, the receiving of the initial document involves receiving the initial document via the file drop or the selection widget.

Some embodiments involve receiving a user indication to add a hotspot annotation to a portion of the modified document. Such embodiments involve annotating the portion of the modified document with the hotspot annotation.

Some embodiments involve generating a social media post comprising the annotated portion of the modified document.

Some embodiments involve sharing the annotated portion of the modified document over a social networking platform.

What is claimed is:

1. A computer-implemented method, comprising:
receiving, by a computing device, an initial document in digital format;
detecting, by the computing device and based on a computerized analysis of the initial document, one or more attributes of the initial document, wherein the one or more attributes comprise a font detail or a vector graphics, or both;
generating, by the computing device and based on the detected one or more attributes, a hierarchical structure associated with the initial document, the hierarchical structure interconnecting one or more components of the initial document;
transforming, by the computing device and based on the hierarchical structure, the initial document to a modified document, wherein the modified document comprises one or more navigable links that facilitate computerized navigation of the hierarchical structure; and
providing, by the computing device, the modified document.

2. The computer-implemented method of claim 1, wherein the one or more attributes comprises the font detail comprising at least one of: a type of font, a font size, or a font color.

3. The computer-implemented method of claim 1, wherein the one or more attributes comprises the vector graphics, and wherein the detecting of the vector graphics comprises detecting a vector graphic intersecting a bounding box of an image in the initial document.

4. The computer-implemented method of claim 1, wherein the one or more attributes comprise one or more structural attributes.

5. The computer-implemented method of claim 4, wherein the one or more structural attributes comprise at least one of: a page attribute, a type of numbering, a line spacing, a callout, a hyperlink, header information, footer information, section information, column structure, page layout, a paragraph layout, position of a text in a line, or part-of-speech (POS) information.

6. The computer-implemented method of claim 1, wherein the one or more attributes comprise one or more content attributes.

7. The computer-implemented method of claim 6, wherein the one or more content attributes comprise at least one of: image content, video content, textual content, or audio content.

8. The computer-implemented method of claim 1, wherein the detecting of the one or more attributes comprises performing an optical character recognition.

9. The computer-implemented method of claim 1, wherein the detecting of the one or more attributes comprises applying a trained machine learning model.

10. The computer-implemented method of claim 1, wherein the initial document is in a portable document format (PDF), and wherein the detecting of the one or more attributes comprises applying a PDF extractor.

11. The computer-implemented method of claim 1, wherein the computing device comprises a user interface configured with a file drop or a selection widget for uploading one or more documents, and wherein the receiving of the initial document further comprises:
receiving the initial document via the file drop or the selection widget.

12. The computer-implemented method of claim 1, further comprising:
receiving a user indication to add a hotspot annotation to a portion of the modified document; and
annotating the portion of the modified document with the hotspot annotation.

13. The computer-implemented method of claim 12, further comprising:
generating a social media post comprising the annotated portion of the modified document.

14. The computer-implemented method of claim 12, further comprising:
sharing the annotated portion of the modified document over a social networking platform.

15. A computing device, comprising:
one or more processors;
a memory; and
data storage, wherein the data storage has stored thereon computer-executable instructions that, when executed by the one or more processors, cause the computing device to carry out functions comprising:
receiving, by the computing device, an initial document;
detecting, by the computing device and based on a computerized analysis of the initial document, one or more attributes of the initial document, wherein the one or more attributes comprise a font detail or a vector graphics, or both;
generating, by the computing device and based on the detected one or more attributes, a hierarchical structure associated with the initial document, the hierarchical structure interconnecting one or more components of the initial document;
transforming, by the computing device and based on the hierarchical structure, the initial document to a modified document, wherein the modified document comprises one or more navigable links that facilitate computerized navigation of the hierarchical structure; and
providing, by the computing device, the modified document.

16. The computing device of claim 15, wherein the one or more attributes comprises the font detail comprising at least one of: a type of font, a font size, or a font color.

17. The computing device of claim 15, wherein the one or more attributes comprises the vector graphics, and wherein the detecting of the vector graphics comprises detecting a vector graphic intersecting a bounding box of an image in the initial document.

18. The computing device of claim 15, wherein the one or more attributes comprise one or more structural attributes.

19. The computing device of claim 15, wherein the one or more attributes comprise one or more content attributes.

20. The computing device of claim 15, wherein the detecting of the one or more attributes comprises performing an optical character recognition.

21. The computing device of claim 15, wherein the detecting of the one or more attributes comprises applying a trained machine learning model.

22. The computing device of claim 15, wherein the initial document is in a portable document format (PDF), and wherein the detecting of the one or more attributes comprises applying a PDF extractor.

23. The computing device of claim 15, the functions comprising:
receiving a user indication to add a hotspot annotation to a portion of the modified document; and
annotating the portion of the modified document with the hotspot annotation.

24. A media sharing system for collaborative media sharing, the system comprising:
one or more processors;
one or more memories; and
data storage, wherein the data storage has stored thereon computer-executable instructions that, when executed by the one or more processors, cause the one or more processors to carry out functions comprising:
providing, by a computing device, a modified document comprising a hierarchical structure representing contents of an initial document in digital format, the hierarchical structure having been generated based on detected one or more attributes of the initial document, the one or more attributes comprising a font detail or a vector graphics, or both, and wherein the modified document comprises one or more navigable links that facilitate computerized navigation of the hierarchical structure;
receiving a user indication to add a hotspot annotation to a portion of the modified document;
annotating the portion of the modified document with the hotspot annotation; and
sharing at least the annotated portion of the modified document over a social networking platform.
